(19) United States
(12) Patent Application Publication
(10) Pub. No.: US 2025/0074484 A1
(43) Pub. Date: Mar. 6, 2025

(54) DEVICE FOR MONITORING RAIL BOGIE AND ASSOCIATED RAIL BOGIE

(71) Applicant: Aktiebolaget SKF, Göteborg (SE)

(72) Inventor: Mikael RÖNNKVIST, Luleå (SE)

(21) Appl. No.: 18/819,801

(22) Filed: Aug. 29, 2024

(30) Foreign Application Priority Data
Sep. 5, 2023 (DE) 102023208532.1

(51) Int. Cl. B61L 15/00; B61F 15/20; B61K 9/06; H01Q 1/22; H01Q 9/04

(52) U.S. Cl. CPC B61L 15/0027; B61F 15/20; B61K 9/06; H01Q 1/22; H01Q 9/0407

(57) ABSTRACT

A device for monitoring rail bogie includes a printed circuit board (14), sensing means (16), and a planar antenna (17). The sensing means (16) measures at least one physical parameter of the rail bogie. The planar antenna (17) is embedded in the printed circuit board. The planar antenna (17) transmits measurements delivered by the sensing means.

### CROSS-REFERENCE TO RELATED APPLICATION

This application claims priority to German Application No. 102023208532.1, filed Sep. 5, 2023, the entirety of which is hereby incorporated by reference.

### FIELD

The present disclosure is directed to the monitoring of rail bogies.

More particularly, the present disclosure deals with a device for monitoring rail bogies and a rail bogie comprising such a device.

### BACKGROUND

Generally, a wagon of a train rests on bogies.

A bogie comprises axle boxes, each axle box comprising an axle supported by bearings and driving wheels of the train.

In order to monitor the bogie to detect for example a failure of a bearing, a wireless monitoring device is generally fixed on the axle box.

The wireless monitoring device may measure vibrations and temperature of the bogie and transmits the measurements of vibrations and temperature for further processing.

To transmit the measurements, the wireless monitoring device may comprise a ceramic antenna solder to a printed circuit board PCB of the wireless monitoring device.

As the wireless monitoring device is fixed on the bogie, the wireless monitoring device is subject to vibrations.

The vibrations of the bogie may detach the ceramic antenna from the PCB by breaking the solder joints or ripping off the copper from the PCB so that the wireless monitoring device cannot transmit the measurements to monitor the bogie.

Consequently, the present disclosure intends to propose to enhance the connection of the antenna on the PCB.

### SUMMARY

According to an aspect, a device for monitoring rail bogie is proposed.

The device comprises a printed circuit board, sensing means configured to measure at least one physical parameter of the rail bogie and a planar antenna embedded in the printed circuit board, the planar antenna being configured to transmit measurements delivered by the sensing means.

The planar antenna is embedded in the PCB so that the planar antenna is directly in the copper of the PCB.

As the planar antenna is embedded in the PCB the planar antenna cannot be detached from the PCB.

Preferably, the device comprises a casing and fixing means arranged at a first end of the casing on an external surface of the casing, the printed circuit board being arranged inside the casing so that the planar antenna is at a second end of the casing, the second end of the casing being opposed to the first end of the casing.

Advantageously, the least one physical parameter comprises one physical parameter of the temperature of the rail bogie and vibrations of the rail bogie.

Advantageously, the printed circuit board supports the sensing means.

Preferably, the planar antenna comprises:
a rectangular loop element comprising a first side element, a second side element parallel to the first side element, a first base element connecting a first end of the first side element to the first end of the second side element, and a second base element comprising a first end connected to the second end of the first side element and a second end forming a terminal of the said antenna, the first side element being longer than the second side element,
a rectangular element inserted in the rectangular loop and comprising a recess, and
a L-shaped element inserted in the recess so that the longest side of the L-shaped element is parallel to the first base element. Advantageously, the planar antenna comprises:
a first rectangular element comprising a first side, a second side parallel to the first side, a third side connecting the first side to the second side and a fourth side parallel to the third side, the first side being longer than the third side,
a first L-shape element connected to the fourth side of the first rectangular element so that the longest side of the first L-shaped element prolongs the first side of the first rectangular element,
a second L-shape element connected to the fourth side of the first rectangular element so that the longest side of the second L-shaped element prolongs the second side of the first rectangular element, the end of the longest side of the second L-shaped element which is not connected to the fourth side of the first rectangular element forming a first terminal, and
a second rectangular element comprising a first side prolongating the longest side of the second L-shaped element with a gap, a second side parallel to the first side regarding the first L shape element, a third side connecting the first and second sides, the third side regarding the second L-shape element, and a fourth side parallel to the third side, the second rectangular element forming a second terminal of the said antenna.

Advantageously, the planar antenna comprises:
a first straight element, a second straight element, a third straight element, a fourth straight element and a fifth straight element, each straight element having a first side, a second side parallel to the first side, a third side connecting the first side to the second side and a fourth side parallel to the third side, the first side being longer than the third side,
the first side of the first straight element, the first side of the second straight element and the first side of the third straight element being parallel,
the second straight element being arranged between the first and the third straight elements,
the fourth straight element connecting a first end of the first straight element and a first end of the third straight element so that the first side of the fourth straight element is perpendicular to the first side of the first straight element,
the fifth straight element connecting the second end of the first straight element and the first side of the second straight element so that the first side of the fifth straight element is parallel to the first side of the fourth straight element, and
the second straight element forming a terminal of the said antenna.

Preferably, the planar antenna comprises:
a first straight element, a second straight element, a third straight element and a fourth straight element, each straight element having a first side, a second side parallel to the first side, a third side connecting the first side to the second side and a fourth side parallel to the third side, the first side being longer than the third side,
a first U-shape element, a second U-shape element and a third U-shape element, each U-shape element comprising a first branch, a second branch parallel to the first branch and a base element, a first end of the first branch being connected to a first end of the base element and a first end of the second branch being connected to a second end of the base element,
the second end of the first branch of the first U-shape element being connected to a first end of the first straight element and the second end of the first branch of the second U-shape element being connected to the second end of the first straight element so that the base element of the first and second U-shape elements is parallel to the first side of the first straight element,
a first end of the second straight element being connected to the second side of the first straight element so that the first side of the second straight element is perpendicular to the second side of the first straight element,
the second end of the second straight element forming a first terminal of the said antenna and being connected to a first end of the third straight element so that the first side of the second straight element is perpendicular to the first side of the third straight element,
the second end of the third straight element being connected to the second end of the first branch of the third U-shape element so that the base element of the third U-shape element is parallel to the first side of the first straight element and so that the base element is between the first straight element and the third straight element, the second end of the second branch of the third U-shape element forming a second terminal of the said antenna,
the first end of the fourth straight element being connected to the second side of the first straight element so that the first side of the fourth straight element is perpendicular to the second side of the first straight element and so that the fourth straight element is between the second straight element and the second U-shape element, and
the second end of the fourth straight element forming a third terminal of the said antenna.

Advantageously, the device further comprises a battery configured to supply the planar antenna and the sensing means.

According to another aspect, a rail bogie comprising a device as defined above is proposed.

Preferably, the rail bogie further comprises an axle box, the device being fixed on the axle box so that the device is on an external side of the rail bogie.

### BRIEF DESCRIPTION OF THE DRAWINGS

Other advantages and features of the present disclosure will appear on examination of the detailed description of embodiments, in no way restrictive, and the appended drawings in which:

FIG. 1 illustrates schematically a train according to the present disclosure;

FIG. 2 illustrates schematically an example of a device for monitoring rail bogie secured on a partial view of an axle box according to the present disclosure;

FIG. 3 illustrates schematically an example of the device according to the present disclosure,

FIG. 4 illustrates schematically an example of the interior of the device according to the present disclosure,

FIG. 5 illustrates schematically a first example of a planar antenna according to the present disclosure,

FIG. 6 illustrates schematically a second example of the planar antenna according to the present disclosure,

FIG. 7 illustrates schematically a third example of the planar antenna according to the present disclosure, and

FIG. 8 illustrates schematically a fourth example of the planar antenna according to the present disclosure.

### DETAILED DESCRIPTION

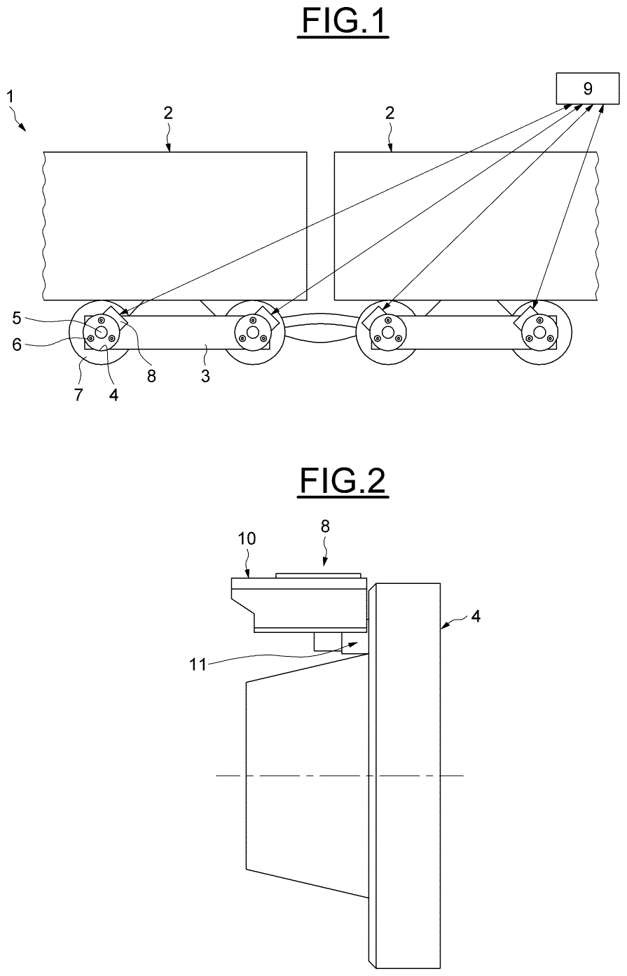

Reference is made to FIG. 1 which represents schematically a train 1 comprising train wagons 2.

Each train wagon 2 comprises a rail bogie 3 including axle boxes 4.

Each axle box 4 comprises a shaft 5 and bearings 6 supporting the shaft 5.

The shaft 5 is driven by an electric motor or an engine (not represented) and drives wheels 7 of the bogie 3.

A device 8 for monitoring rail bogie is fixed on each axel box 4 so that the device 8 is on an external side of the rail bogie 4.

The device 8 is intended to measure at least one physical parameter of the bogie 4 and transmit wirelessly the measurements of the physical parameter to a processing unit 9.

The processing unit 9 is intended to process the received measurements and to determine the state of wear of the bogie 3, for example by determining the state of wear of the bearings 6, the start of wear of the wheels 7 or the axle box.

The physical parameter may be the temperature of the bogie or the vibrations endured by the bogie.

In a variant, the device 8 is intended to measure two physical parameters, for example the temperature of the bogie and the vibrations of the bogie.

The devices 8 and the processing unit 9 form a monitoring system for monitoring rail bogies 3.

FIG. 2 illustrates schematically an example of the device 8 secured on a partial view of the axle box 4.

The device 8 comprises a casing 10 and fixing means 11 arranged at a first end of the casing on an external surface of the casing 10.

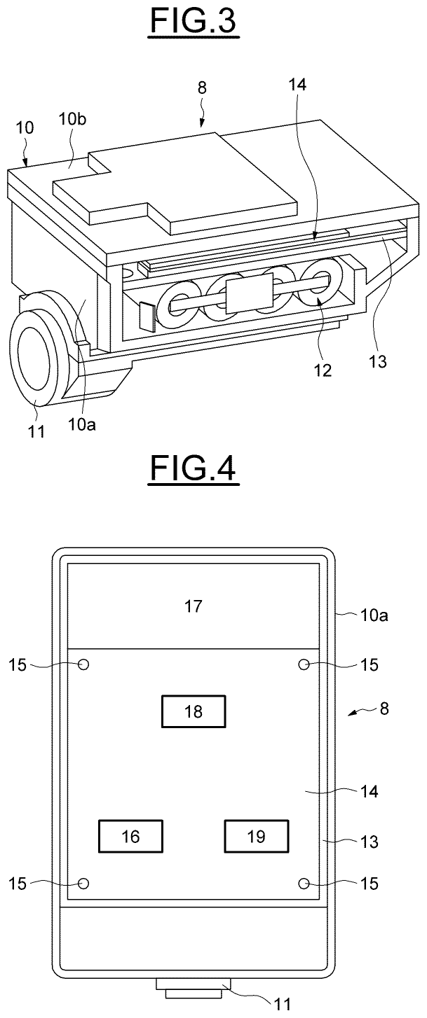

FIG. 3 illustrates schematically an example of the device 8 wherein a part of the casing 10 is removed.

The fixing means 11 comprise for example a flange and the axle box 4 comprises for example a pin, the pin being inserted in the flange and secured in the flange.

The casing 10 comprises an enclosure 10a and a lid 10b closing the enclosure 10a.

The device 8 comprises batteries 12 resting on the bottom of the enclosure 10a.

The casing 10 may further comprise a support part 13 located between the lid 10b and the batteries 12.

The device 8 further comprises a print circuit board PCB 14 secured on the support 13 so that the print circuit board 14 may be visible when the lid 10b is removed from the enclosure 10a.

FIG. 4 illustrates the example of the device 8 when the lid 10b is removed from the enclosure 10a.

The PCB 14 is secured on the support part 13 for example with screws 15.

The PCB 14 comprises sensing means 16 intended to measure the at least one physical parameter, an embedded planar antenna 17, an antenna impedance matching circuit 18 connected to the planar antenna 17 and a processing unit 19.

The PCB 14 supports the sensing means 16, the antenna impedance matching circuit 18 and the processing unit 19.

The processing unit 19 is intended to implement the sensing means 16 so that the sensing means 16 deliver measurements of the at least one physical parameter, and is intended to transmit the measurements to the antenna impedance matching circuit 18 so that the planar antenna 17 transmits the measurements to the processing unit 9.

The batteries 12 are intended to supply the sensing means 16 and the processing unit 19 with power.

The PCB 14 is arranged inside the casing so that the planar antenna 17 is at a second end of the casing 10a, the second end of the casing 10a being opposed to the first end of the casing.

The planar antenna 17 is located on an outside side of the bogie 3 and as far as possible from the axle box 4 so that electromagnetic waves emitted by the planar antenna 17 are not disturbed by metal parts of the bogie 3.

The electromagnetic waves emitted by the planar antenna 17 may be radio waves.

The planar antenna 17 is embedded in the PCB 14 so that the planar antenna 17 is directly in the copper of the PCB 14.

As the planar antenna 17 is embedded in the PCB 14, the planar antenna 17 cannot be detached from the PCB 14.

The planar antenna 17 is manufactured from known methods to realize integrated circuit tracks.

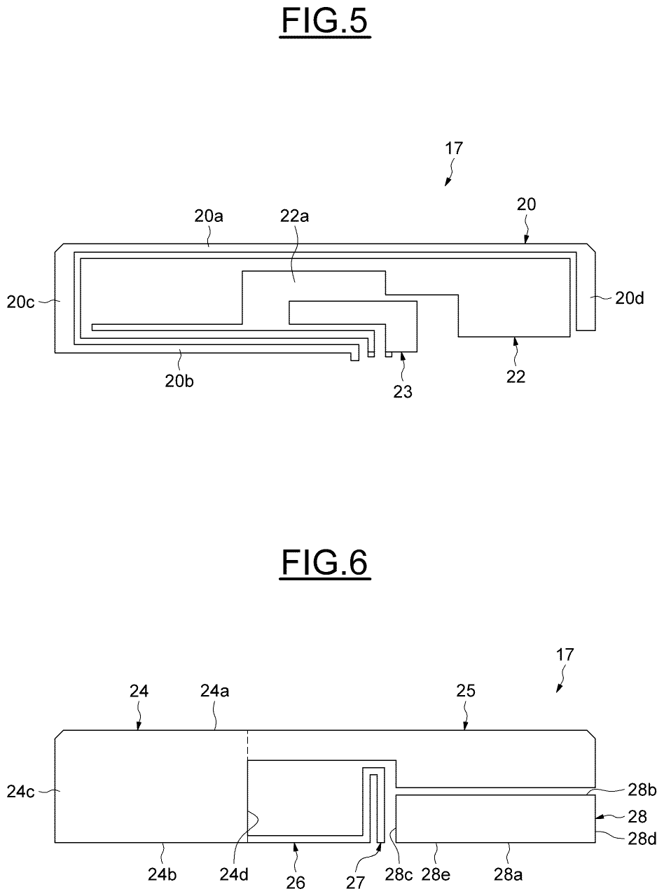

FIG. 5 illustrates schematically a first example of the planar antenna 17.

The planar antenna 17 comprises a rectangular loop element 20 comprising a first side element 20a and a second side element 20b parallel to the first side element 20a.

The rectangular loop element 20 further comprises a second base element 20c connecting a first end of the first side element 20a to the first end of the second side element 20b and a second base element 20d comprising a first end connected to the second end of the first side element 20a.

The first side element 20a is longer than the second side element 20b.

The second end of the second side element 20b forms a terminal 21 of the said antenna connected to the impedance matching circuit 18.

The planar antenna 17 further comprises a rectangular element 22 inserted in the rectangular loop 20 and comprising a recess 22a.

The planar antenna 17 comprises a L-shaped element 23 inserted in the recess 22a so that the longest side of the L-shaped element 23 is parallel to the first base element 22a.

FIG. 6 illustrates schematically a second example of the planar antenna 17.

The planar antenna 17 comprises a first rectangular element 24 comprising a first side 24a, a second side 24b parallel to the first side 24a, a third side 24c connecting the first side 24a to the second side 24b and a fourth side 24d parallel to the third side 24c.

The first side 24a is longer than the third side 24c.

The planar antenna 17 further comprises a first L-shape element 25 connected to the fourth side 24d of the first rectangular element 24 so that the longest side of the first L-shaped element 25 prolongs the first side 24a of the first rectangular element 24.

The planar antenna 17 comprises a second L-shape element 26 connected to the fourth side 24d of the first rectangular element 24 so that the longest side of the second L-shaped element 26 prolongs the second side 24b of the first rectangular element 24.

The end of the longest side of the second L-shaped element 24 which is not connected to the fourth side 24d of the first rectangular element 24 forms a first terminal 27.

The planar antenna 17 further comprises a second rectangular element 28 comprising a first side 28a prolongating the longest side of the second L-shaped element 27 with a gap, a second side 28b parallel to the first side 28a regarding the first L-shape element 25.

The second rectangular element 28 further comprises a third side 28c connecting the first and second sides 28a, 28b.

The third side 28c regards the second L-shape element 26.

The second rectangular element 28 comprises a fourth side 28d parallel to the third side 28c.

The second rectangular element 28 forms a second terminal of the said antenna and comprises a connecting point 28c.

The first terminal 27 and the connecting point 28e of the second terminal 28 are connected to the impedance matching circuit 18.

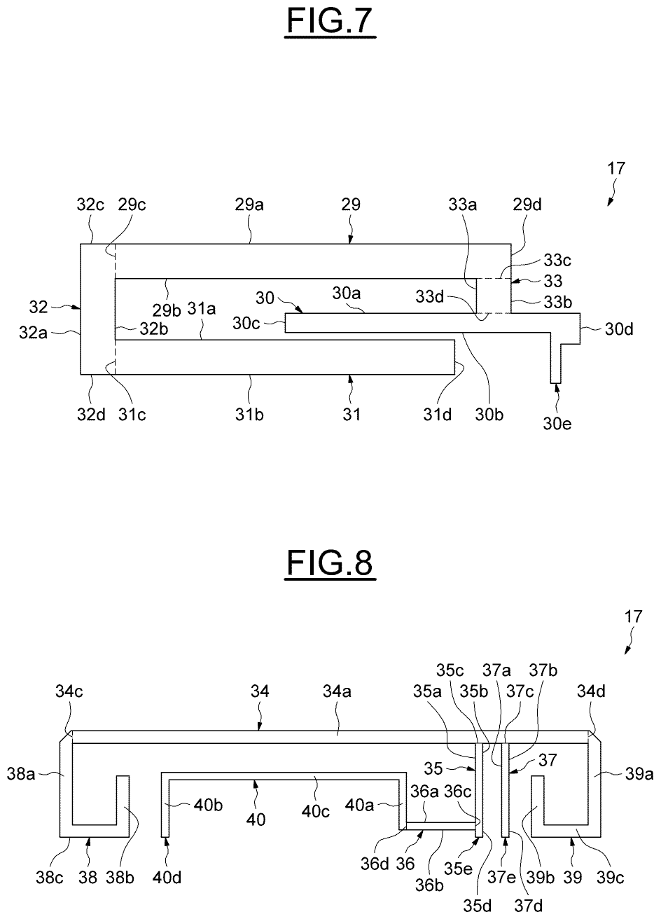

FIG. 7 illustrates schematically a third example of the planar antenna 17.

The planar antenna comprises a first straight element 29, a second straight element 30, a third straight element 31, a fourth straight element 32 and a fifth straight element 33.

Each straight element 29, 30, 31, 32, 33 has a first side 29a, 30a, 31a, 32a, 33a, a second side 29b, 30b, 31b, 32b, 33b parallel to the first side 29a, 30a, 31a, 32a, 33a.

Each straight element 29, 30, 31, 32, 33 further has a third side 29c, 30c, 31c, 32c, 33c connecting the first side 29a, 30a, 31a, 32a, 33a to the second side 29b, 30b, 31b, 32b, 33b and a fourth side 29d, 30d, 31d, 32d, 33d parallel to the third side 29c, 30c, 31c, 32c, 33c.

The first side 29a, 30a, 31a, 32a, 33a is longer than the third side 29c, 30c, 31c, 32c, 33c.

The first side 29a of the first straight element 29, the first side 30a of the second straight element 30 and the first side 31a of the third straight element 31 are parallel.

The second straight element 30 is arranged between the first and the third straight elements 29, 31.

The fourth straight element 32 connects a first end of the first straight element 29 and a first end of the third straight element 31 so that the first side 32a of the fourth straight element 32 is perpendicular to the first side 29a of the first straight element 29.

The third side 29c of the first straight element 29 is in contact with the second side 32b of the fourth straight element 32 and the third side 31c of the third straight element 31 is in contact with the second side 32b of the fourth straight element 32.

The fifth straight element 33 connects the second end of the first straight element 29 and the first side 30a of the second straight element 30 so that the first side 33a of the fifth straight element 33 is parallel to the first side 32a of the fourth straight element 32.

The third side 33c of the fifth straight element 33 is in contact with the second side 29b of the first straight element 29 and the fourth side 33c of the fifth straight element 33 is in contact with the first side 30a of the first straight element 30.

The second straight element 30 forms a terminal of the said antenna and comprises a connecting point 30c.

The connecting point 30e of the second straight element 30 is connected to the impedance matching circuit 18.

FIG. 8 illustrates schematically a fourth example of the planar antenna 17.

The planar antenna 17 comprises a first straight element 34, a second straight element 35, a third straight element 36 and a fourth straight element 37.

Each straight element 34, 35, 36, 37 has a first side 34a, 35a, 36a, 37a and a second side 34b, 35b, 36b, 37b parallel to the first side 34a, 35a, 36a, 37a.

Each straight element 34, 35, 36, 37 further has a third side 34c, 35c, 36c, 37c connecting the first side 34a, 35a, 36a, 37a to the second side 34b, 35b, 36b, 37b and a fourth side 34d, 35d, 36d, 37d parallel to the third side 34c, 35c, 36c, 37c.

The planar antenna 17 further comprises a first U-shape element 38, a second U-shape element 39 and a third U-shape element 40.

Each U-shape element 38, 39, 40 comprises a first branch 38a, 39a, 40a, a second branch 38b, 39b, 40b parallel to the first branch 38a, 39a, 40a and a base element 38c, 39c, 40c.

A first end of the first branch 38a, 39a, 40a is connected to a first end of the base element 38c, 39c, 40c and a first end of the second branch 38b, 39b, 40b is connected to a second end of the base element 38c, 39c, 40c.

The second end of the first branch 38a of the first U-shape element 38 is connected to a first end of the first straight element 34 and the second end of the first branch 39a of the second U-shape element 39 is connected to the second end of the first straight element 34 so that the base element 38c, 39c of the first and second U-shape elements 38, 39 is parallel to the first side 34a of the first straight element 34.

The third side 34c of the first straight element 34 is in contact with a first side of the first branch 38a of the first U-shape element 38 so that the second end of the second branch 38b of the first U-shape element 38 is in regard with the second side of the first straight element 34 and the fourth side 34d of the first straight element 34 is in contact with a first side of the first branch 39a of the second U-shape element 39 so that the second end of the second branch 39b of the second U-shape element 39 is in regard with the second side of the first straight element 34.

A first end of the second straight element 35 is connected to the second side 34b of the first straight element 34 so that the first side 35a of the second straight element 35 is perpendicular to the second side 34b of the first straight element 34.

The third side 35c of the second straight element 35 is in contact with the second side 34b of the first straight element 34.

The second end of the second straight element 35 forms a first terminal of the said antenna so that for example a connecting point 35e on the fourth side 35d of the second straight element 35 is connected to the impedance matching circuit 18.

The second end of the second straight element 35 is connected to a first end of the third straight element 36 so that the first side 35b of the second straight element 35 is perpendicular to the first side 36a of the third straight element 36.

The third side 36c of the third straight element 36 is in contact with the first side 35a of the second straight element 35.

The second end of the third straight element 36 is connected to the second end of the first branch 40a of the third U-shape element 40 so that the base element 40c of the third U-shape element 40 is parallel to the first side 34a of the first straight element 34 and so that the base element 40c is between the first straight element 34 and the third straight element 36.

A first side surface of the first branch 40a of the third U-shape element 40 is in contact with the fourth side 36d of the third straight element 36.

The second end of the second branch 40b of the third U-shape 40 forms a first terminal of the said antenna so that for example a connecting point 40d of the second end of the second branch 40b of the third U-shape 40 is connected to the impedance matching circuit 18.

The first end of the fourth straight element 37 is connected to the second side 34b of the first straight element 34 so that the first side 37a of the fourth straight element 37 is perpendicular to the second side 34b of the first straight element 34 and so that the fourth straight element 37 is between the second straight element 35 and the second U-shape element 39.

The third side surface 37c of the fourth straight element 37 is in contact with the second side surface 34b of the first straight element 34.

The second end of the fourth straight element 37 forms a second terminal of the said antenna so that for example a connecting point 37e on the fourth side 37d of the fourth straight element 37 is connected to the impedance matching circuit 18.

The person skill in the art is able to determine the arrangement and the value of capacitors and inductances to design the impedance matching circuit 18 according to the example of the planar antenna 17 connected to the impedance matching circuit 18 and according to the frequency range in which the planar antenna emits electromagnetic waves comprising the measurements.

What is claimed is:

1. A device for monitoring rail bogie, the device comprising:
a printed circuit board,
sensing means configured to measure at least one physical parameter of the rail bogie, and
a planar antenna embedded in the printed circuit board, the planar antenna being configured to transmit measurements delivered by the sensing means.

2. The device according to claim 1, comprising a casing and fixing means arranged at a first end of the casing on an external surface of the casing, the printed circuit board being arranged inside the casing so that the planar antenna is at a second end of the casing, the second end of the casing being opposed to the first end of the casing.

3. The device according to claim 1, wherein the least one physical parameter comprises one physical parameter of the temperature of the rail bogie and vibrations of the rail bogie.

4. The device according to claim 1, wherein the printed circuit board supports the sensing means.

5. The device according to claim 1, wherein the planar antenna comprises:
a rectangular loop element comprising a first side element, a second side element parallel to the first side element, a first base element connecting a first end of the first side element to the first end of the second side element, and a second base element comprising a first end connected to the second end of the first side element and a second end forming a terminal of the said antenna, the first side element being longer than the second side element,
a rectangular element inserted in the rectangular loop and comprising a recess, and
a L-shaped element inserted in the recess so that the longest side of the L-shaped element is parallel to the first base element.

6. The device according to claim 1, wherein the planar antenna comprises:
a first rectangular element comprising a first side, a second side parallel to the first side, a third side connecting the first side to the second side and a fourth side parallel to the third side, the first side being longer than the third side,
a first L-shape element connected to the fourth side of the first rectangular element so that the longest side of the first L-shaped element prolongs the first side of the first rectangular element,
a second L-shape element connected to the fourth side of the first rectangular element so that the longest side of the second L-shaped element prolongs the second side of the first rectangular element, the end of the longest side of the second L-shaped element which is not connected to the fourth side of the first rectangular element forming a first terminal, and
a second rectangular element comprising a first side prolongating the longest side of the second L-shaped element with a gap, a second side parallel to the first side regarding the first L shape element, a third side connecting the first and second sides, the third side regarding the second L shape element, and a fourth side parallel to the third side, the second rectangular element forming a second terminal of the said antenna.

7. The device according to claim 1, wherein the planar antenna comprises:
a first straight element, a second straight element, a third straight element, a fourth straight element and a fifth straight element, each straight element having a first side, a second side parallel to the first side, a third side connecting the first side to the second side and a fourth side parallel to the third side, the first side being longer than the third side,
the first side of the first straight element, the first side of the second straight element and the first side of the third straight element being parallel,
the second straight element being arranged between the first and the third straight elements,
the fourth straight element connecting a first end of the first straight element and a first end of the third straight element so that the first side of the fourth straight element is perpendicular to the first side of the first straight element,
the fifth straight element connecting the second end of the first straight element and the first side of the second straight element so that the first side of the fifth straight element is parallel to the first side of the fourth straight element, and
the second straight element forming a terminal of the said antenna.

8. The device according to claim 1, wherein the planar antenna comprises:
a first straight element, a second straight element, a third straight element and a fourth straight element, each straight element having a first side, a second side parallel to the first side, a third side connecting the first side to the second side and a fourth side parallel to the third side, the first side being longer than the third side,
a first U-shape element, a second U-shape element and a third U-shape element, each U-shape element comprising a first branch, a second branch parallel to the first branch and a base element, a first end of the first branch being connected to a first end of the base element and a first end of the second branch being connected to a second end of the base element,
the second end of the first branch of the first U shape element being connected to a first end of the first straight element and the second end of the first branch of the second U shape element being connected to the second end of the first straight element so that the base element of the first and second U shape elements is parallel to the first side of the first straight element,
a first end of the second straight element being connected to the second side of the first straight element so that the first side of the second straight element is perpendicular to the second side of the first straight element,
the second end of the second straight element forming a first terminal of the said antenna and being connected to a first end of the third straight element so that the first side of the second straight element is perpendicular to the first side of the third straight element,
the second end of the third straight element being connected to the second end of the first branch of the third U shape element so that the base element of the third U shape element is parallel to the first side of the first straight element and so that the base element is between the first straight element and the third straight element, the second end of the second branch of the third U shape element forming a second terminal of the said antenna,
the first end of the fourth straight element being connected to the second side of the first straight element so that the first side of the fourth straight element is perpendicular to the second side of the first straight element and so that the fourth straight element is between the second straight element and the second U shape element, and
the second end of the fourth straight element forming a third terminal of the said antenna.

9. The device according to claim 1, further comprising a battery configured to supply the planar antenna and the sensing means.

10. The device according to claim 2, wherein the least one physical parameter comprises one physical parameter of the temperature of the rail bogie and vibrations of the rail bogie.

11. The device according to claim 10, wherein the printed circuit board supports the sensing means.

12. The device according to claim 11, wherein the planar antenna comprises:
a rectangular loop element comprising a first side element, a second side element parallel to the first side element, a first base element connecting a first end of the first side element to the first end of the second side element, and a second base element comprising a first end connected to the second end of the first side element and a second end forming a terminal of the said antenna, the first side element being longer than the second side element,
a rectangular element inserted in the rectangular loop and comprising a recess, and
a L-shaped element inserted in the recess so that the longest side of the L-shaped element is parallel to the first base element.

13. The device according to claim 11, wherein the planar antenna comprises:
a first rectangular element comprising a first side, a second side parallel to the first side, a third side connecting the first side to the second side and a fourth side parallel to the third side, the first side being longer than the third side,
a first L-shape element connected to the fourth side of the first rectangular element so that the longest side of the first L-shaped element prolongs the first side of the first rectangular element,
a second L-shape element connected to the fourth side of the first rectangular element so that the longest side of the second L-shaped element prolongs the second side of the first rectangular element, the end of the longest side of the second L-shaped element which is not connected to the fourth side of the first rectangular element forming a first terminal, and
a second rectangular element comprising a first side prolongating the longest side of the second L-shaped element with a gap, a second side parallel to the first side regarding the first L shape element, a third side connecting the first and second sides, the third side regarding the second L shape element, and a fourth side parallel to the third side, the second rectangular element forming a second terminal of the said antenna.

14. The device according to claim 11, wherein the planar antenna comprises:
a first straight element, a second straight element, a third straight element, a fourth straight element and a fifth straight element, each straight element having a first side, a second side parallel to the first side, a third side connecting the first side to the second side and a fourth side parallel to the third side, the first side being longer than the third side,
the first side of the first straight element, the first side of the second straight element and the first side of the third straight element being parallel,
the second straight element being arranged between the first and the third straight elements,
the fourth straight element connecting a first end of the first straight element and a first end of the third straight element so that the first side of the fourth straight element is perpendicular to the first side of the first straight element,
the fifth straight element connecting the second end of the first straight element and the first side of the second straight element so that the first side of the fifth straight element is parallel to the first side of the fourth straight element, and
the second straight element forming a terminal of the said antenna.

15. The device according to claim 11, wherein the planar antenna comprises:
a first straight element, a second straight element, a third straight element and a fourth straight element, each straight element having a first side, a second side parallel to the first side, a third side connecting the first side to the second side and a fourth side parallel to the third side, the first side being longer than the third side,
a first U-shape element, a second U-shape element and a third U-shape element, each U-shape element comprising a first branch, a second branch parallel to the first branch and a base element, a first end of the first branch being connected to a first end of the base element and a first end of the second branch being connected to a second end of the base element,
the second end of the first branch of the first U shape element being connected to a first end of the first straight element and the second end of the first branch of the second U shape element being connected to the second end of the first straight element so that the base element of the first and second U shape elements is parallel to the first side of the first straight element,
a first end of the second straight element being connected to the second side of the first straight element so that the first side of the second straight element is perpendicular to the second side of the first straight element,
the second end of the second straight element forming a first terminal of the said antenna and being connected to a first end of the third straight element so that the first side of the second straight element is perpendicular to the first side of the third straight element,
the second end of the third straight element being connected to the second end of the first branch of the third U shape element so that the base element of the third U shape element is parallel to the first side of the first straight element and so that the base element is between the first straight element and the third straight element, the second end of the second branch of the third U shape element forming a second terminal of the said antenna,
the first end of the fourth straight element being connected to the second side of the first straight element so that the first side of the fourth straight element is perpendicular to the second side of the first straight element and so that the fourth straight element is between the second straight element and the second U shape element, and
the second end of the fourth straight element forming a third terminal of the said antenna.

16. The device according to claim 15, further comprising a battery configured to supply the planar antenna and the sensing means.

17. A rail bogie comprising a device according to claim 16.

18. The rail bogie according to claim 17, further comprising an axle box, the device being fixed on the axle box so that the device is on an external side of the rail bogie.

19. A rail bogie comprising a device according to claim 1.

20. The rail bogie according to claim 19, further comprising an axle box, the device being fixed on the axle box so that the device is on an external side of the rail bogie.
